(19) United States
(12) Patent Application Publication
(10) Pub. No.: US 2026/0361382 A1
(43) Pub. Date: Nov. 12, 2026

(54) METHOD OF BEAM REPORTING AND RELEVANT DEVICES

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/731,528

(22) Filed: Jul. 6, 2026

Related U.S. Application Data
(63) Continuation of application No. PCT/CN2025/072480, filed on Jan. 15, 2025.
(60) Provisional application No. 63/555,371, filed on Feb. 19, 2024.

(51) Int. Cl. H04B 7/06; H04W 24/10; H04W 72/21

(52) U.S. Cl. CPC H04B 7/06952; H04W 24/10; H04W 72/21

(57) ABSTRACT

A method of beam reporting and relevant devices are provided. The method by a terminal device includes performing beam measurements based on a list of reference signals from a network device to obtain beam measurement results; and transmitting a beam report with some of the beam measurement results to the network device when one or more conditions for beam reporting are met.

### CROSS-REFERENCE TO RELATED APPLICATIONS

This application is a continuation of International Application No. PCT/CN2025/072480 filed on Jan. 15, 2025, which claims priority to U.S. application No. 63/555,371 filed on Feb. 19, 2024, the disclosures of the prior applications are hereby incorporated by reference in their entireties.

### BACKGROUND OF DISCLOSURE

NR/5G system supports FR2 (frequency range 2) operation. The NR system in FR2 is generally a multi-beam-based system, where the gNB has multiple downlink Tx beams that are available for downlink transmission and the UE could have multiple Rx beams available for downlink transmission reception. For the uplink transmission, the UE might have multiple Tx beams available for transmission and the gNB has multiple uplink Rx beams that are available for uplink reception. To support proper communication, the gNB and the UE may identify the best pair of gNB Tx beam and UE Rx beam. The NR introduces beam measurement and reporting in CSI framework to support the selection of best Tx beam and Rx beam. The NR also supports the functions of beam indication for downlink reception and uplink transmission. The gNB can indicate the information of Tx beam of PDCCH and PDSCH to the UE to assist the downlink reception at the UE side. The gNB can also indicate the information of Tx beam of PUSCH, PUCCH and SRS to the UE to indicate the UE about how to transmit the PUSCH, PUCCH and SRS.

The NR/5G systems implement the function of beam indication through the signaling of TCI states. The UE can be first provided with a list of joint TCI states or a list of DL TCI states and a list of UL TCI states. Each joint TCI state can provide the configuration information of QCL typeD for downlink reception (where the QCL typeD provides the spatial Rx parameter for downlink reception) and reference information of UL Tx spatial filter for uplink transmission. Each joint TCI state can be associated with a set of uplink power control parameters, including PO, alpha, index of closed loop power control and the pathloss RS. Each DL TCI state can provide the configuration information of QCL typeD for downlink reception. Each UL TCI state can provide the reference information of UL Tx spatial filter for uplink transmission and each UL TCI state can also be associated with a set of uplink power control parameters, including PO, alpha, index of closed loop and pathloss RS.

The gNB can indicate on joint TCI state or a pair of DL TCI states and UL TCI states to the UE through a DCI signaling. When the UE receives the DCI signaling for TCI state indication, the UE feedbacks one ACK to the gNB. Then the indicated TCI state(s) should be applied starting from the first slot that is at least beamAppTime symbols after the last symbols of the PUCCH or PUSCH that carries the ACK. From the information of QCL TypeD in the indicated TCI state, the UE would derive the Rx beam for receiving the PDCCH and PDSCH. From the information of UL Tx spatial filter in the indicated TCI state, the UE would derive the Tx beam for transmitting the PUSCH, PUCCH and/or SRS. From the indicated TCI state, the UE would derive the uplink power control parameters and pathloss RS and then calculate the uplink transmit power for the PUSCH, PUCCH and/or SRS transmission.

To support the system to choose proper TCI states, the NR specification also supports the functions of beam measurement and reporting. The system can configure the UE to measure a set of reference signals, such as CSI-RS resources and/or SS/PBCH blocks and the UE can be requested to report the measurement results to the system. The reported measurement result can include the indicator of selected CSI-RS resource or SS/PBCH and the corresponding L1-RSRP or L1-SINR measurement.

The main drawback of the existing method of beam measurement and reporting is that the gNB controls the beam measurement and reporting but the gNB might not know the beam quality very well. That might cause two consequences: firstly, if the system configures very frequent beam reporting, the reporting would cost large overhead and thus the uplink transmission efficiency is impaired. On the other hand, if the system configures less frequent beam reporting, the reporting overhead that is reduced by the system cannot obtain the channel information in time.

### SUMMARY

The present application relates to the field of communication systems, and more particularly, to a method of beam reporting and relevant devices.

In a first aspect, some embodiments of the present application provide a method of beam reporting, performed by a terminal device, including performing beam measurements based on a list of reference signals from a network device to obtain beam measurement results; and transmitting a beam report with some of the beam measurement results to the network device when one or more conditions for beam reporting are met.

In a second aspect, some embodiments of the present application provide a method of beam reporting, performed by a network device, including configuring a terminal device with a list of reference signals for the terminal device to perform beam measurements based on the list of reference signals to obtain beam measurement results; and receiving from the terminal device a beam report with some of the beam measurement results when one or more conditions for beam reporting are met.

In a third aspect, some embodiments of the present application provide a terminal device, including a memory; and a processor coupled to the memory, wherein the processor is configured to call and run program instructions stored in the memory, to execute the method described in the first aspect.

### BRIEF DESCRIPTION OF DRAWINGS

In order to illustrate the embodiments of the present application or related art more clearly, the following figures will be described in the embodiments are briefly introduced. It is obvious that the drawings are merely some embodiments of the present application, a person having ordinary skill in this field can obtain other figures according to these figures without paying the premise.

FIG. 1 is a block diagram of a terminal device and a network device in a wireless communication system according to an embodiment of the present application.

FIG. 2 is a flowchart illustrating a method of beam reporting by a terminal device according to an embodiment of the present application.

FIG. 3 is a flowchart illustrating a method of beam reporting by a network device according to an embodiment of the present application.

FIG. 4 is a block diagram of a terminal device according to an embodiment of the present application.

FIG. 5 is a block diagram of a network device according to an embodiment of the present application.

FIG. 6 is a block diagram of a system for wireless communication according to an embodiment of the present application.

### DETAILED DESCRIPTION OF EMBODIMENTS

Embodiments of the present application are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In this document, the symbol “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

The following table includes some abbreviations or explanations used in some embodiments of the present application:

| Abbreviation | Full name |
|---|---|
| 3GPP | 3rd Generation Partnership Project |
| 5G | 5th Generation |
| NR | New Radio |
| gNB | Next generation NodeB |
| DL | Downlink |
| UL | Uplink |
| PUSCH | Physical Uplink Shared Channel |
| PUCCH | Physical Uplink Control Channel |
| PDSCH | Physical Downlink Shared Channel |
| PDCCH | Physical Downlink Control Channel |
| PRACH | Physical Random Access Channel |
| SRS | Sounding Reference Signal |
| CC | Component Carrier |
| CSI | Channel state information |
| CSI-RS | Channel state information |
| | reference signal |
| CSI-IM | Channel state information- |
| | interference measurement |
| NZP CSI-RS | Non-zero-power Channel state |
| | information reference signal |
| RS | Reference Signal |
| CORESET | Control Resource Set |
| DCI | Downlink control information |
| TRP | Transmission/reception point |
| ACK | Acknowledge |
| NACK | Non-Acknowledge |
| UCI | Uplink control information |
| RRC | Radio Resource Control |
| HARQ | Hybrid Automatic Repeat Request |
| MAC | Media Access Control |
| CRC | Cyclic Redundancy Check |
| RNTI | Radio Network Temporary Identity |
| RB | Resource Block |
| PRB | Physical Resource Block |
| NW | Network |
| RSRP | Reference signal received power |
| L1-RSRP | Layer 1 Reference signal received |
| | power |
| TCI | Transmission Configuration Indicator |
| Tx | Transmission |
| Rx | Receive |
| QCL | Quasi co-location |
| SSB | SS/PBCH Block |
| PBCH | Physical broadcast channel |
| SSS | Secondary synchronization signal |
| CRI | CSI-RS resource indicator |
| SSBRI | SS/PBCH block resource indicator |
| SINR | Signal to Interference Noise Ratio |
| L1-SINR | Layer 1 Signal to Interference |
| | Noise Ratio |
| DMRS | Demodulation Reference Signal |
| PCell | Primary Cell |
| SCell | Secondary Cell |

The present application proposes terminal device (e.g., UE)-initiated beam reporting. Further, the present application provides solutions for physical resource configuration for UE-initiated beam reporting. For example, the UE can be configured with two physical resources, that is, a first physical resource and a second physical resource. The UE may then transmit one bit information in the first physical resource and that indicates whether the UE transmits beam reporting in the corresponding second physical resource.

An object of the present application is to propose a method of beam reporting and relevant devices, which can solve issues in the relevant art, reduce low latency and low signaling overhead in determining the best beam, expand the deployment scenarios, provide a good communication performance, and/or provide high reliability.

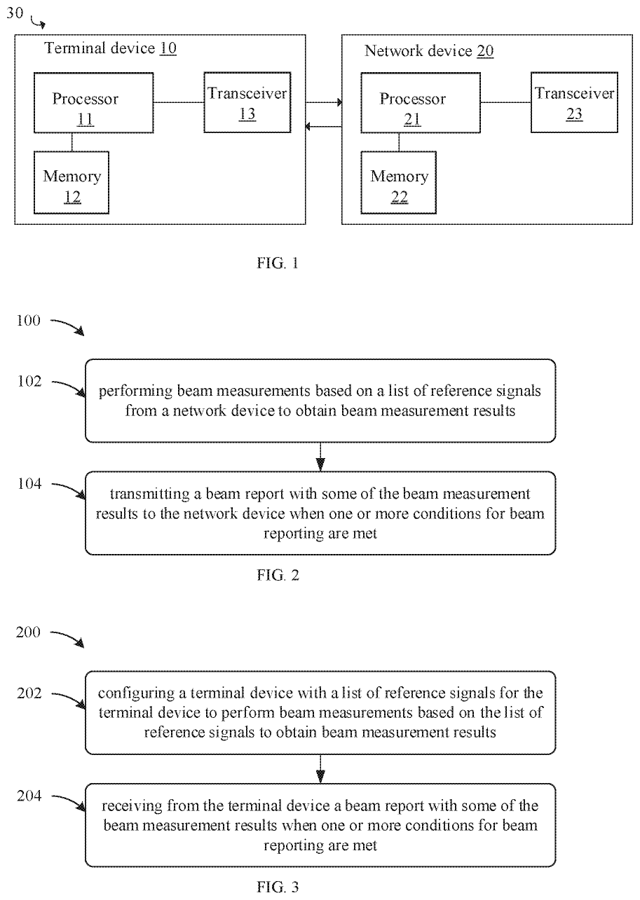

FIG. 1 illustrates that, in some embodiments, one or more terminal device (e.g., user equipments (UEs)) 10 and one or more network devices (e.g., base stations or gNBs) 20 in a wireless communication system 30 according to an embodiment of the present application are provided. The wireless communication system 30 includes the one or more terminal devices 10 and one or more network devices 20. The one or more terminal devices 10 may include a memory 12, a transceiver 13, and a processor 11 coupled to the memory 12 and the transceiver 13. The one or more network devices 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal. When the wireless communication system 30 complies with the New Radio (NR) standard of the 3rd Generation Partnership Project (3GPP), the next generation core network is a backend serving network system and may include an Access and Mobility Management Function (AMF), User Plane Function (UPF), and a Session Management Function (SMF). In one aspect, the terminal device 10 can include almost any consumer electronic device or appliance that can connect to a radio access network and a core network for the releases of 3GPP and further, such as, but not limited to NR networks.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 of the terminal device 10 is utilized to perform beam measurements based on a list of reference signals from a network device to obtain beam measurement results; and transmit a beam report with some of the beam measurement results to the network device when one or more conditions for beam reporting are met. With the method of terminal device (e.g., UE)-initiated beam reporting, this facilitates the switching to the best beam for downlink transmission (and uplink transmission) with low latency and low signaling overhead and thus the system performance system would be improved.

In some embodiments, the processor 21 of the network device 20 is utilized to configure a terminal device with a list of reference signals for the terminal device to perform beam measurements based on the list of reference signals to obtain beam measurement results; and receive from the terminal device a beam report with some of the beam measurement results when one or more conditions for beam reporting are met. With the method of terminal device (e.g., UE)-initiated beam reporting, this facilitates the switching to the best beam for downlink transmission (and uplink transmission) with low latency and low signaling overhead and thus the system performance system would be improved.

FIG. 2 illustrates a method of beam reporting 100 by a terminal device according to an embodiment of the present application. In some embodiments, the method 100 includes the following. In Block 102, the terminal device (e.g., a user equipment (UE)) performs beam measurements based on a list of reference signals from a network device (e.g., a base station or gNB) to obtain beam measurement results. For example, the terminal device can be provided with a list of CSI-RS resources and/or SS/PBCH blocks and the terminal device can be requested to measure beam measurements on those configured CSI-RS resources and SS/PBCH blocks. In Block 104, the terminal device transmits a beam report with some of the beam measurement results to the network device when one or more conditions for beam reporting are met. For example, when some conditions of the beam measurement results or some event of the beam measurement results happens, the terminal device can be requested to report the beam measurement results of some CSI-RS resource and/or SS/PBCH blocks to the network device. That is, the beam report is a terminal device-initiated beam report or UE-initiated beam report.

The proposed UE-initiated beam reporting method can support the system to switch to the best beam for downlink transmission (and uplink transmission) with low latency and low signaling overhead and thus the system performance system would be improved.

In some embodiments, the method may further include being configured with a first physical resource (e.g., a PUCCH resource) and a second physical resource (e.g., a PUCCH resource or a PUSCH resource) for the beam reporting; and transmitting an indicator information in the first physical resource to indicate whether the terminal device transmits the beam report in the second physical resource.

In some embodiments, the indicator information may be a one-bit indicator information. More specifically, the one-bit indicator information may carry a first value in the first physical resource to indicate that the second physical resource is not occupied; or the one-bit indicator information may carry a second value in the first physical resource to indicate that the second physical resource is used to transmit the beam report.

In some embodiments, the indicator information may be used to indicate whether any number of the reference signals are reported, and how many reference signals are reported in the second physical resource if at least one of the reference signals is reported. More specifically, the indicator information may carry a first value in the first physical resource to indicate that the second physical resource is not occupied; or the indicator information may carry a second value in the first physical resource to indicate the number of the reference signals is reported in the second physical resource. For example, when the indicator information carries a value of k in the first physical resource, k reference signals may be reported in the beam report transmitted in the second physical resource.

In some embodiments, the first physical resource and the second physical resource may be of same periodicity. One instance of the first physical resource may be associated with at least one instance of the second physical resource. For example, an n-th instance of the first physical resource may be associated with the at least one instance of the second physical resource that is after the n-th instance of the first physical resource and before an (n+1)-th instance of the first physical resource. More particularly, the indicator information transmitted in one instance of the first physical resource indicates transmission of the beam reporting transmitted in the instance of the second physical resource that is associated with the one instance of the first physical resource.

FIG. 3 illustrates a method of beam reporting 200 by a network device according to an embodiment of the present application. In some embodiments, the method 200 includes the following. In Block 202, the network device (e.g., base station or gNB) configures a terminal device (e.g., user equipments (UEs)) with a list of reference signals (e.g., CSI-RS resources and/or SS/PBCH blocks) for the terminal device to perform beam measurements based on the list of reference signals to obtain beam measurement results. In Block 204, the network device receives from the terminal device a beam report with some of the beam measurement results when one or more conditions for beam reporting are met. This facilitates terminal device-initiated beam reporting or UE-initiated beam reporting. Other details of the method 200 may be referred to the method 100 described above and are not repeated herein.

Further details about the invention are provided below.

In one embodiment, the UE can be configured with UE-initiated beam reporting. The UE can be provided with a list of CSI-RS resources and/or SS/PBCH blocks and the UE can be requested to measure beam measurements on those configured CSI-RS resources and SS/PBCH blocks. When some conditions of the beam measurement results or some event of the beam measurement results happens, the UE can be requested to report the beam measurement results of some CSI-RS resource and/or SS/PBCH blocks to the gNB. For example, the UE can report L1-RSRP measurement of one or more CSI-RS resources and/or SS/PBCH blocks and the UE can report one or more CRIs/SSRIs and corresponding L1-RSRP or differential L1-RSRP of each reported CRI/SSBRI. For example, the UE can report L1-SINR measurement of one or more CSI-RS resources and/or SS/PBCH blocks and the UE can report one or more CRIs/SSRIs and corresponding L1-SINR or differential L1-SINR of each reported CRI/SSBRI. For example, for each reported CRI or SSBRI in UE-initiated beam reporting, the UE can also report one UE capability set index value. The UE can be provided the configuration of two physical resources: a first physical resource and a second physical resource. In the first physical resource, the UE can report on indicator information that is used to indicate whether the UE transmit UE-initiated beam report in the second physical resource. For example, the UE can transmit one indicator in the first physical resource, which can take value 0 or 1. When the indicator in the first physical resource takes value of 0, the UE does not occupy the second physical resource. When the indicator in the first physical resource takes value of 1, the UE uses the second physical resource to transmit UE-initiated beams reporting. For another example, the UE can transmit one indicator in the first physical resource, which can report the number of CRIs/SSBRIs reported in the second physical resource. When the indicator in the first physical resource takes value of 0, the UE does not occupy the second physical resource. When the indicator in the first physical resource takes value of k>0, the UE uses the second physical resource to transmit UE-initiated beams reporting containing the beam reporting of k CRIs/SSBRIs. The first physical resource can be a PUCCH or PUSCH. The second physical resource can be a PUCCH or PUSCH.

In a first method, the UE can be provided the configuration of a first PUCCH resource and a second PUCCH resource for the UE-initiated beam reporting. For each PUCCH resource, the UE can be provided with the location of slot (slot offset) and periodicity. In one example, the UE can be provided with one same periodicity for the first PUCCH resource and the second PUCCH resource. The UE can be provided with the association between one instance of the first PUCCH resource and instance of the second PUCCH resource. For example, the n-th instance of the first PUCCH resource is associated with the instance of the second PUCCH resource that is after the n-th instance of the first PUCCH resource and before the (n+1)-th instance of the first PUCCH resource. In each instance of the first PUCCH resource, the UE can transmit one indicator that indicates the transmission of UE-initiated beam reporting transmitted in the instance of the second PUCCH resource that is associated with this instance of the first PUCCH resource.

In one example, in the n-th instance of the first PUCCH resource, the UE can transmit one indicator that indicates if the UE transmits UE-initiated beam reporting in the instance(s) of the second PUCCH resource that is associated with the n-th instance of the first PUCCH resource. For example, the UE can transmit one indicator in the n-th instance of the first PUCCH resource and this indicator can take value of 0 or 1. When the indicator takes value of 0, the UE does not occupy the instance(s) of the second PUCCH resource that is associated with the n-th instance of the first PUCCH resource. When the indicator takes value of 1, the UE transmits UE-initiated beam report in the instance(s) of the second PUCCH resource that is associated with the n-th instance of the first PUCCH resource.

For example, the UE can transmit one indicator in the n-th instance of the first PUCCH resource and this indicator can take value of 0 or k>0. When the indicator takes value of 0, the UE does not occupy the instance(s) of the second PUCCH resource that is associated with the n-th instance of the first PUCCH resource. When the indicator takes value of k>0, the UE transmits UE-initiated beam report in the instance(s) of the second PUCCH resource that is associated with the n-th instance of the first PUCCH resource and in each reporting instance, the UE reports k CRIs/SSBRIs and the corresponding L1-RSRP/differential L1-RSRP measurement (or L1-SINR/differential L1-SINR measurement).

In a second method, the UE can be provided the configuration of a first PUCCH resource and a second PUSCH resource for the UE-initiated beam reporting. For the first PUCCH resource and the second PUSCH resource, the UE can be provided with the location of slot (slot offset) and periodicity. In one example, the UE can be provided with one same periodicity for the first PUCCH resource and the second PUSCH resource. The UE can be provided with the association between one instance of the first PUCCH resource and instance of the second PUSCH resource. For example, the n-th instance of the first PUCCH resource is associated with the instance of the second PUSCH resource that is after the n-th instance of the first PUCCH resource and before the (n+1)-th instance of the first PUCCH resource. In each instance of the first PUCCH resource, the UE can transmit one indicator that indicates the transmission of UE-initiated beam reporting transmitted in the instance of the second PUSCH resource that is associated with this instance of the first PUCCH resource.

In one example, in the n-th instance of the first PUCCH resource, the UE can transmit one indicator that indicates if the UE transmits UE-initiated beam reporting in the instance(s) of the second PUSCH resource that is associated with the n-th instance of the first PUCCH resource. For example, the UE can transmit one indicator in the n-th instance of the first PUCCH resource and this indicator can take value of 0 or 1. When the indicator takes value of 0, the UE does not occupy the instance(s) of the second PUSCH resource that is associated with the n-th instance of the first PUCCH resource. When the indicator takes value of 1, the UE transmits UE-initiated beam report in the instance(s) of the second PUSCH resource that is associated with the n-th instance of the first PUCCH resource.

For example, the UE can transmit one indicator in the n-th instance of the first PUCCH resource and this indicator can take value of 0 or k>0. When the indicator takes value of 0, the UE does not occupy the instance(s) of the second PUSCH resource that is associated with the n-th instance of the first PUCCH resource. When the indicator takes value of k>0, the UE transmits UE-initiated beam report in the instance(s) of the second PUSCH resource that is associated with the n-th instance of the first PUCCH resource and in each reporting instance, the UE reports k CRIs/SSBRIs and the corresponding L1-RSRP/differential L1-RSRP measurement (or L1-SINR/differential L1-SINR measurement).

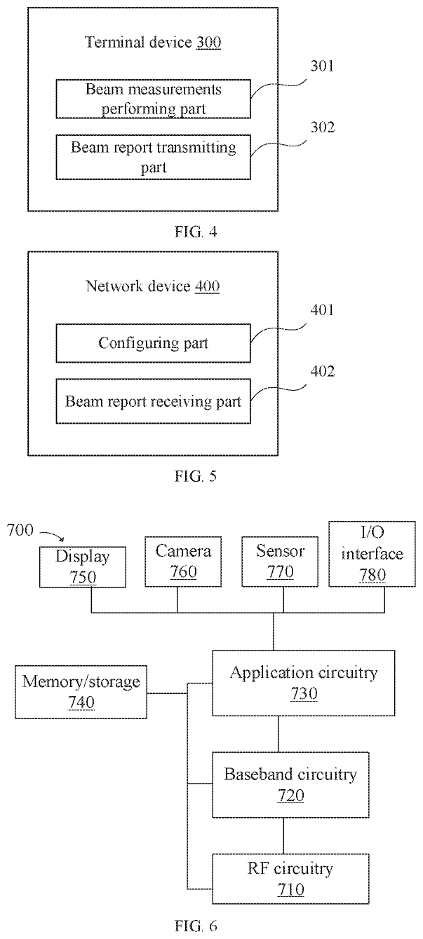

FIG. 4 illustrates a terminal device 300 according to an embodiment of the present application. The terminal device 300 includes a beam measurements performing part 301 and a beam report transmitting part 302. The beam measurements performing part 301 is configured to perform beam measurements based on a list of reference signals from a network device to obtain beam measurement results. The beam report transmitting part 302 is configured to transmit a beam report with some of the beam measurement results to the network device when one or more conditions for beam reporting are met. Other details of the terminal device 300 may be referred to the methods described above and are not repeated herein.

FIG. 5 illustrates a network device 400 according to an embodiment of the present application. The terminal device 400 includes a configuring part 401 and a beam report receiving part 402. The configuring part 401 is configured to configure a terminal device with a list of reference signals for the terminal device to perform beam measurements based on the list of reference signals to obtain beam measurement results. The beam report receiving part 402 is configured to receive from the terminal device a beam report with some of the beam measurement results when one or more conditions for beam reporting are met. Other details of the network device 400 may be referred to the methods described above and are not repeated herein.

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Commercial interests for some embodiments are as follows. 1. Solving issues in the related art. 2. Reducing low latency and low signaling overhead in determining the best beam. 3. Providing a good communication performance. 4. Providing high reliability. Some embodiments of the present application are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. The deployment scenarios include, but not limited to, indoor hotspot, dense urban, urban micro, urban macro, rural, factor hall, and indoor D2D scenarios. Some embodiments of the present application are a combination of “techniques/processes” that can be adopted in 3GPP specification to create an end product. Some embodiments of the present application could be adopted in 5G NR licensed and non-licensed or shared spectrum communications. Some embodiments of the present application propose technical mechanisms. The present example embodiment is applicable to NR in unlicensed spectrum (NR-U). The present application can be applied to other mobile networks, in particular to mobile network of any further generation cellular network technology (6G, etc.).

FIG. 6 is a block diagram of an example system 700 for wireless communication according to an embodiment of the present application. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN), 5G NR (New Radio) network, and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present application are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present application. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present application can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present application can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present application. The storage medium includes a USB disk, a mobile hard disk, a read-only memory (ROM), a random access memory (RAM), a floppy disk, or other kinds of media capable of storing program codes.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A method of beam reporting, performed by a terminal device, comprising:
performing beam measurements based on a list of reference signals from a network device to obtain beam measurement results; and
transmitting a beam report with some of the beam measurement results to the network device when one or more conditions for beam reporting are met.

2. The method of claim 1, wherein the beam report is a terminal device-initiated beam report.

3. The method of claim 1, further comprising:
being configured with a first physical resource and a second physical resource for the beam reporting; and
transmitting an indicator information in the first physical resource to indicate whether the terminal device transmits the beam report in the second physical resource.

4. The method of claim 3, wherein the indicator information is one-bit indicator information.

5. The method of claim 4, wherein the one-bit indicator information carries a first value in the first physical resource to indicate that the second physical resource is not occupied; or the one-bit indicator information carries a second value in the first physical resource to indicate that the second physical resource is used to transmit the beam report.

6. The method of claim 3, wherein the indicator information is used to indicate whether any number of the reference signals are reported, and how many reference signals are reported in the second physical resource if at least one of the reference signals is reported.

7. The method of claim 6, wherein the indicator information carries a first value in the first physical resource to indicate that the second physical resource is not occupied; or the indicator information carries a second value in the first physical resource to indicate the number of the reference signals is reported in the second physical resource.

8. The method of claim 7, wherein when the indicator information carries a value of k in the first physical resource, k reference signals are reported in the beam report transmitted in the second physical resource.

9. The method of claim 3, wherein at least one of the first physical resource and the second physical resource is a physical uplink control channel (PUCCH) resource or a physical uplink shared channel (PUSCH) resource.

10. The method of claim 3, wherein the first physical resource and the second physical resource are of same periodicity.

11. A method of beam reporting, performed by a network device, comprising:
configuring a terminal device with a list of reference signals for the terminal device to perform beam measurements based on the list of reference signals to obtain beam measurement results; and
receiving from the terminal device a beam report with some of the beam measurement results when one or more conditions for beam reporting are met.

12. The method of claim 11, further comprising:
configuring the terminal device with a first physical resource and a second physical resource for the beam reporting; and
receiving from the terminal device an indicator information in the first physical resource to indicate whether the terminal device transmits the beam report in the second physical resource.

13. The method of claim 12, wherein the indicator information is one-bit indicator information.

14. The method of claim 13, wherein the one-bit indicator information carries a first value in the first physical resource to indicate that the second physical resource is not occupied; or the one-bit indicator information carries a second value in the first physical resource to indicate that the second physical resource is used to transmit the beam report.

15. The method of claim 12, wherein at least one of the first physical resource and the second physical resource is a physical uplink control channel (PUCCH) resource or a physical uplink shared channel (PUSCH) resource.

16. A terminal device, comprising:
a memory; and
a processor coupled to the memory,
wherein the processor is configured to call and run program instructions stored in the memory, to:
perform beam measurements based on a list of reference signals from a network device to obtain beam measurement results; and
transmit a beam report with some of the beam measurement results to the network device when one or more conditions for beam reporting are met.

17. The terminal device of claim 16, wherein the processor is further configured to:
be configured with a first physical resource and a second physical resource for the beam reporting; and
transmit an indicator information in the first physical resource to indicate whether the terminal device transmits the beam report in the second physical resource.

18. The terminal device of claim 17, wherein the indicator information is one-bit indicator information.

19. The terminal device of claim 18, wherein the one-bit indicator information carries a first value in the first physical resource to indicate that the second physical resource is not occupied; or the one-bit indicator information carries a second value in the first physical resource to indicate that the second physical resource is used to transmit the beam report.

20. The terminal device of claim 17, wherein at least one of the first physical resource and the second physical resource is a physical uplink control channel (PUCCH) resource or a physical uplink shared channel (PUSCH) resource.
